(19) United States
(12) Patent Application Publication
(10) Pub. No.: US 2005/0013681 A1
(43) Pub. Date: Jan. 20, 2005

(54) Non-current conducting nut

(76) Inventors: John F. Carvalho, Danbury, CT (US); Michael J. Bardelli, New Milford, CT (US); Carlton J. Creighton, New Milford, CT (US); John M. Huntley, Trumbull, CT (US)

Correspondence Address: HARNESS, DICKEY & PIERCE, P.L.C., P.O. BOX 828, BLOOMFIELD HILLS, MI, 48303, US

(21) Appl. No.: 10/870,875

(22) Filed: Jun. 17, 2004

Related U.S. Application Data
(60) Provisional application No. 60/480,131, filed on Jun. 20, 2003.

(51) Int. Cl. F16B 39/34

(52) U.S. Cl. 411/438

(57) ABSTRACT

A threaded fastener includes a non-metallic carrier defining an outer surface and an inner surface. A metallic helical coil insert is integrally molded in the inner surface to define a set of internal threads within the non-metallic carrier.

### CROSS-REFERENCE TO RELATED APPLICATIONS

This application claims the benefit of U.S. Provisional Application No. 60/480,131, filed on Jun. 20, 2003. The disclosure(s) of the above application is incorporated herein by reference.

### FIELD OF THE INVENTION

The present invention relates to a fastener component and, more particularly, to a plastic nut having a helically coiled insert integrally molded therein to provide an electrically insulated fastener component.

### BACKGROUND AND SUMMARY OF THE INVENTION

Non-metallic fasteners have inherently weak threads but are non-conductive and rust-resistant. Metallic threaded parts have relatively strong threads but are heavy, electrically conductive and prone to rust. Accordingly, there is a need in the fastener art to provide an improved fastener which incorporates the advantages of each of the above class of fasteners.

The present invention provides a metallic helical coil screw thread insert integrally molded within a non-metallic nut, rendering a stronger thread. The resulting fastener provides a lightweight, non-conducting, rust-resistant nut. The present invention may be provided in virtually any configuration—e.g., crown nut, wing, nut, cap nut, etc.—thread size or color. Moreover, the threads could be any size (metric or English in locking or non-locking types.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top plan view of a first preferred embodiment of the present invention;

FIG. 2 is a partial cross-section of the nut illustrated in FIG. 1;

FIG. 3 is a partial cross-section of a second preferred embodiment of the present invention; and

FIG. 4 is a partial cross-section of a third preferred embodiment of the present invention.

### DETAILED DESCRIPTION OF THE PREFERRED EMBODIMENTS

The following description of the preferred embodiments is merely exemplary in nature and is in no way intended to limit the invention, its application, or uses.

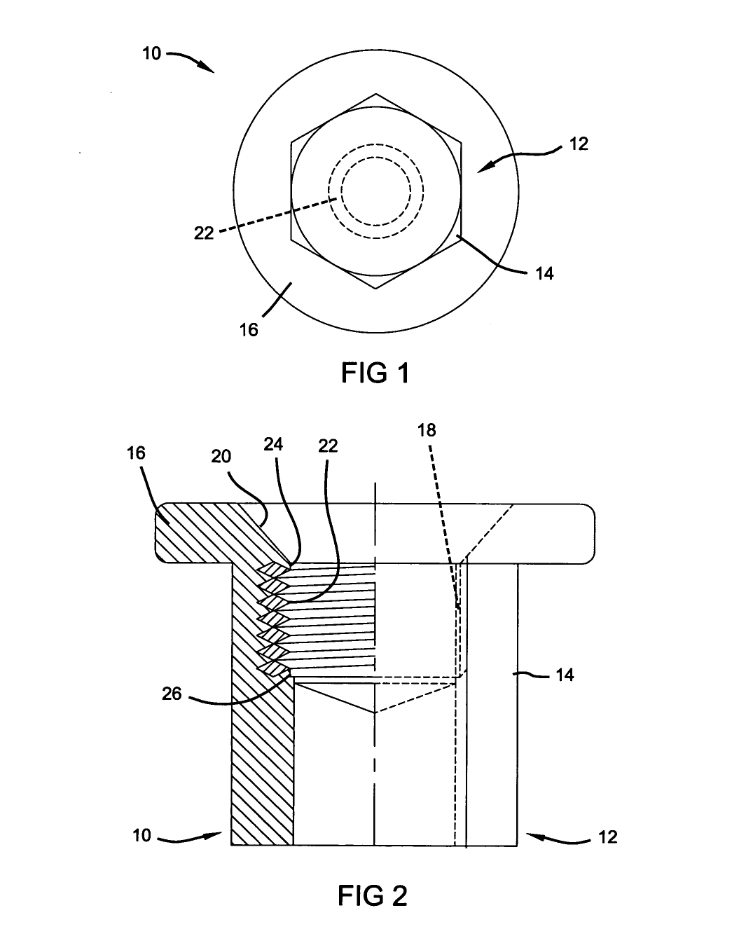

With reference now to FIGS. 1 and 2, a first preferred embodiment of the present invention is provided. Threaded fastener 10 includes a carrier 12 having a nut portion 14 extending from an annular flange 16. The nut portion 14 defines an exterior surface formed in a generally hexagonal configuration to provide a tool interface surface and an interior surface 18. An aperture 20 is formed through annular flange 16 and communicates with inner surface 18.

A helical coil insert 22 is integrally molded within the interior surface 18 of the carrier 12. In this manner, the helical coil insert 22 provides a metallic thread interface with an interior surface 18 of carrier 12. Retaining elements 24, 26 are formed in carrier 12 and extend inwardly at the interior surface 18 to capture and retain helical coil insert 22 within carrier 12.

The metallic helical coil insert 22 is preferably manufactured from one of the following materials: stainless steel, Inconel X, nitronic, CRS or titanium. However, one skilled in the art will readily recognize that any suitable metal or metal alloy which provides sufficient mechanical properties may be utilized for the helically coil insert. A presently preferred helically coil insert is available from Emhart Fasteners, Model No.1084-5CN075 M5x08 wire insert.

As presently preferred, the carrier 12 is manufactured from a non-metallic, moldable material such as nylon, polycarbonate, phenolic, delin or ABS. However, one skilled in the art will recognize that any suitable non-metallic, moldable material which has suitable mechanical and material properties may be used for a given application. As illustrated in FIGS. 1 and 2, thread fastener 10 is a hexagonal flange nut in which the helically insert 22 extends partially through body 14.

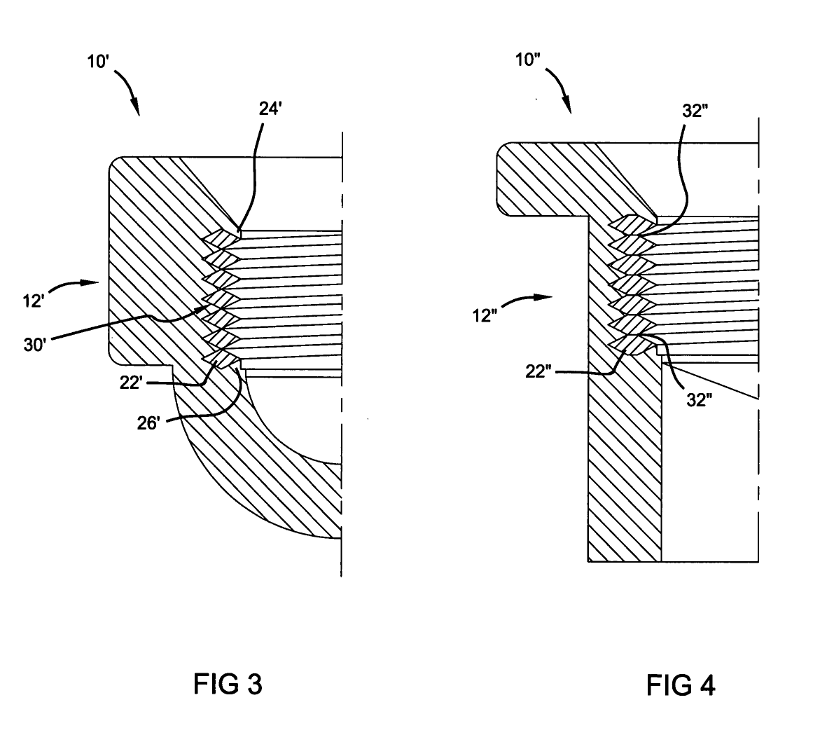

With reference now to FIG. 3, a second preferred embodiment of the present invention is illustrated as a hexagonal cap nut 10′ having a non-metallic carrier 12′ and a metallic helical coil insert 22′. Carrier 12′ has a pair of retaining elements 24′, 26′ disposed on opposing ends of helical coil insert 22′. Retaining elements 24′, 26′ function to axially locate and retain the helical coil insert 22′ within the carrier 12′. Furthermore, one skilled in the art will recognize that the zig-zag interface 30′ between the helical coil insert 22 and the interior surface 18′ of the carrier 12′ provides sufficient friction to react the torsional loads imparted by the bolt or threaded stud (not shown) for the given application. In this regard, the outer surface of the helical coil inset may include geometric features or may be otherwise surface treated to insure proper adhesion between the non-metallic carrier 12′ and the metallic helical insert 22′.

With reference now to FIG. 4, a third preferred embodiment is illustrated. Threaded fastener 10″ include a non-metallic carrier 12″ and a metallic threaded helical insert 22″. Threaded fastener 10″ is substantially similar to the threaded fastener 10′ illustrated in FIG. 2. However, as can be recognized from a comparison of FIG. 4 and FIG. 2, the helical coil insert 22″ is provided with a flat area 32″ between adjacent helical coils. In this manner, a tighter interface is achieved between adjacent turns within helical coil insert 22″ such that the plastic material which forms the carrier 12″ and does not flow through the coil interfaces during the molding process. As such, the internal threads of thread fastener remain clear of any obstruction as a result of the manufacturing process.

While the present invention has been described with reference to certain preferred embodiments directed to a hexagonal cap nut and a hexagonal flange nut, one skilled in the art will readily recognize that the present invention may be readily adapted to a wide variety of threaded fastener applications including hex nuts, flange nuts, wing nuts, thumb nuts, cap nuts, crown nuts, dress nuts and the like.

The description of the invention is merely exemplary in nature and, thus, variations that do not depart from the gist of the invention are intended to be within the scope of the invention. Such variations are not to be regarded as a departure from the spirit and scope of the invention.

1. A threaded fastener comprising:
a non-metallic carrier defining an outer surface and an inner surface; and
a metallic helical coil insert integrally molded in said inner surface to define a set of internal threads within said non-metallic carrier.

2. The threaded fastener of claim 1 wherein said non-metallic carrier further comprises a retaining element extending inwardly from said inner surface at an end of said metallic helical coil insert.

3. The threaded fastener of claim 1 wherein said metallic helical coil insert is made from a material selected from the group consisting of stainless steel, Inconel X, nitronic, CRS and titanium.

4. The threaded fastener of claim 1 wherein said non-metallic carrier is made from a material selected from the group consisting of nylon, polycarbonate, phenolic, delin and ABS.

5. The threaded fastener of claim 1 wherein said non-metallic carrier is one of the types selected from the group consisting of a hex nut, a flange nut, a wing nut, a thumb nut, a cap nut, a crown nut and a dress nut.

6. A threaded fastener comprising:
a non-metallic carrier defining an outer surface and an inner surface; and
a metallic helical insert arranged on said inner surface to define threads within said non-metallic carrier;
wherein said metallic insert extends radially into said carrier from said inner surface a predetermined distance intermediate said inner and outer surface.

7. The threaded fastener of claim 6 wherein said metallic helical insert defines a first and second end along a longitudinal axis, wherein at least one of said first and second ends are bounded by said non-metallic carrier.

8. The threaded fastener of claim 6 wherein said metallic insert is molded into said non-metallic carrier.

9. The threaded fastener of claim 6 wherein said metallic helical coil insert is made from a material selected from the group consisting of stainless steel, Inconel X, nitronic, CRS and titanium.

10. The threaded fastener of claim 6 wherein said non-metallic carrier is made from a material selected from the group consisting of nylon, polycarbonate, phenolic, delin and ABS.

11. A threaded fastener comprising:
a non-metallic carrier defining an outer surface and an inner surface; and
a metallic insert arranged on said non-metallic carrier to define a set of internal threads on said inner surface.

12. The threaded fastener of claim 11 wherein said metallic insert extends radially into said carrier from said inner surface a predetermined distance intermediate said inner and outer surface.

13. The threaded fastener of claim 11 wherein said metallic insert defines a cross-section having a series of zig-zag wall portions.

14. The threaded fastener of claim 11 wherein said metallic insert defines a series of adjacent helical coils, said series of adjacent helical coils interfacing an adjacent helical coil at a flat interface area defined along a cross section of said metallic insert.

15. The threaded fastener of claim 11 wherein said metallic insert is molded into said non-metallic carrier.

16. The threaded fastener of claim 11 wherein said metallic helical coil insert is made from a material selected from the group consisting of stainless steel, Inconel X, nitronic, CRS and titanium.

17. The threaded fastener of claim 11 wherein said non-metallic carrier is made from a material selected from the group consisting of nylon, polycarbonate, phenolic, delin and ABS.
